(19) United States
(12) Patent Application Publication
(10) Pub. No.: US 2022/0185202 A1
(43) Pub. Date: Jun. 16, 2022

(54) BELT MOLDING

(71) Applicants: TOKAI KOGYO CO., LTD., Obu-shi (JP); HONDA MOTOR CO., LTD., Tokyo (JP)

(72) Inventors: Nobufumi UI, Obu-shi (JP); Kazuyoshi SAITO, Tokyo (JP); Takayuki KAWAI, Tokyo (JP); Kazuaki HIWATASHI, Tokyo (JP)

(73) Assignees: TOKAI KOGYO CO., LTD., Obu-shi (JP); HONDA MOTOR CO., LTD., Tokyo (JP)

(21) Appl. No.: 17/545,908

(22) Filed: Dec. 8, 2021

(30) Foreign Application Priority Data
Dec. 10, 2020 (JP) 2020-205215

(51) Int. Cl. B60R 13/04; B60J 10/75

(52) U.S. Cl. CPC B60R 13/04; B60J 10/75

(57) ABSTRACT

A long belt molding including: a molding main body including vehicle interior and exterior lateral wall portions, a top wall portion, a design lip, and a vehicle interior lip; and an end cap attached to an end of the molding main body and including a lid portion, a cover portion, and a base portion, wherein the base portion extends from the lid portion and is at least partially fixed to a vehicle-interior-side surface of the vehicle interior lateral wall portion, and the cover portion protrudes obliquely downward toward the vehicle interior lip from at least a part of an upper end of the base portion and, in a state where the belt molding is mounted on a door panel, at least a part of the cover portion is in contact with the vehicle interior lip to close a gap between the design lip and the vehicle interior lip.

### CROSS-REFERENCE TO RELATED APPLICATIONS

This application is based upon and claims the benefit of priority from prior Japanese patent application No. 2020-205215, filed on Dec. 10, 2020, the entire contents of which are incorporated herein by reference.

### TECHNICAL FIELD

The present disclosure relates to a long belt molding configured to be mounted along an upper edge of a door panel of a vehicle door to which a window pane is attached so as to be able to be moved up and down.

### BACKGROUND ART

As this type of belt molding (also referred to as molding), for example, as described in Patent Literature 1 (JP-A-2019-131037), there is one in which, on an vehicle-interior-side surface of a base portion of a belt molding, a lip for sealing a gap between the base portion and a window pane is formed to protrude obliquely upward toward a vehicle interior side (window pane side) and, at an upper end of the base portion, a design lip (decorative lip) which decorates an upper surface side of the belt molding is formed to protrude to the vehicle interior side (window pane side).

In Patent Literature 1 described above, part of wind flowing along the window pane when a vehicle is traveling enters a V-shaped groove (gap between the base portion and the lip) in the belt molding through a gap between the window pane and the design lip. As a result, wind noise is generated and enters the vehicle. Especially when driving at high speed, this wind noise becomes harshness of ears.

### SUMMARY

An aspect of the present disclosure provides a belt molding capable of reducing wind noise during vehicle traveling.

According to an aspect of the present disclosure, there is provided a long belt molding configured to be mounted along an upper edge of a door panel of a vehicle door to which a window pane is attached so as to be able to be moved up and down, the belt molding including: a long molding main body including: a vehicle interior lateral wall portion and a vehicle exterior lateral wall portion which face each other; a top wall portion which connects an upper side of the vehicle interior lateral wall portion and an upper side of the vehicle exterior lateral wall portion; a design lip which protrudes from an upper end of the vehicle interior lateral wall portion to a vehicle interior side; and a vehicle interior lip which protrudes obliquely upward from a part of the vehicle interior lateral wall portion which is located lower than the design lip toward the vehicle interior side, the vehicle interior lip configured to seal a gap between the vehicle interior lateral wall portion and the window pane; and an end cap attached to an end of the molding main body in a longitudinal direction of the molding main body, the end cap including: a lid portion which closes at least a part of an end surface opening of the molding main body in the longitudinal direction; a cover portion which closes at least a part of an opening between the design lip and the vehicle interior lip; and a base portion which connects the lid portion and the cover portion, wherein the base portion is located between the design lip and the vehicle interior lip, extends in the longitudinal direction from the lid portion along a vehicle-interior-side surface of the vehicle interior lateral wall portion, and is at least partially fixed to the vehicle-interior-side surface of the vehicle interior lateral wall portion, and wherein the cover portion protrudes obliquely downward toward the vehicle interior lip from at least a part of an upper end of the base portion and, in a state where the belt molding is mounted along the upper edge of the door panel, at least a part of the cover portion is in contact with the vehicle interior lip to close a gap between the design lip and the vehicle interior lip.

According to this configuration, the cover portion of the end cap attached to the end of the molding main body in the longitudinal direction closes a V-shaped groove between the vehicle interior lateral wall portion of the belt molding and the vehicle interior lip. Therefore, it is possible to prevent traveling wind flowing along the window pane from entering the V-shaped groove. As a result, wind noise when the vehicle is traveling can be reduced and harshness of ears can be prevented.

### BRIEF DESCRIPTION OF DRAWINGS

FIG. 1 is an external view of a door mirror and its peripheral portion as viewed from the side;

FIG. 2 is a perspective view of a main part of a belt molding as viewed from a vehicle exterior side;

FIG. 3 is a perspective view of a state in which an insertion portion of an end cap is pulled out from a molding main body of the belt molding as viewed from the vehicle exterior side;

FIG. 4 is an exploded perspective view of the belt molding as viewed from a vehicle interior side;

FIG. 5 is a perspective view of the belt molding as viewed from the vehicle interior side;

FIG. 6 is a cross-sectional view taken along the line VI-VI of the belt molding of FIG. 5;

FIG. 7 is a cross-sectional view taken along the line VII-VII of the belt molding of FIG. 5; and

FIG. 8 is a cross-sectional view taken along a same line as FIG. 6, illustrating a state in which a vehicle interior lip of the belt molding mounted along an upper edge of a door panel is in contact with a window pane and deformed.

### DESCRIPTION OF EMBODIMENT

Hereinafter, an embodiment of the present disclosure will be described based on a belt molding of a front door of a vehicle.

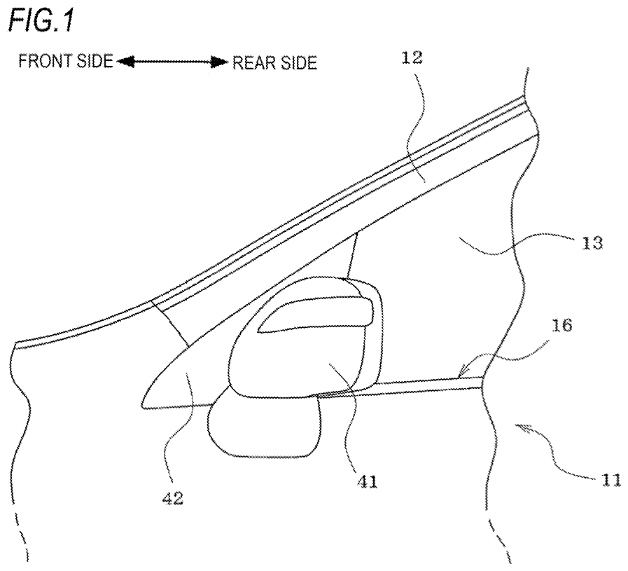

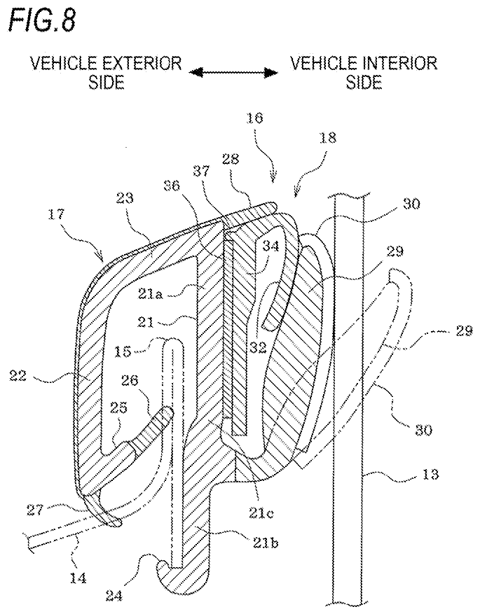

As illustrated in FIG. 1, a window frame 12 is integrally provided on a front door 11 of the vehicle and a window pane 13 (window glass) for opening or closing a window opening formed by the window frame 12 is provided so as to be able to moved up and down. A long belt molding 16 is attached to a flange portion 15 (see FIG. 8) provided on an upper edge (window opening edge) of an outer door panel 14 of the front door 11 and the belt molding 16 covers a portion between the outer door panel 14 and the window pane 13.

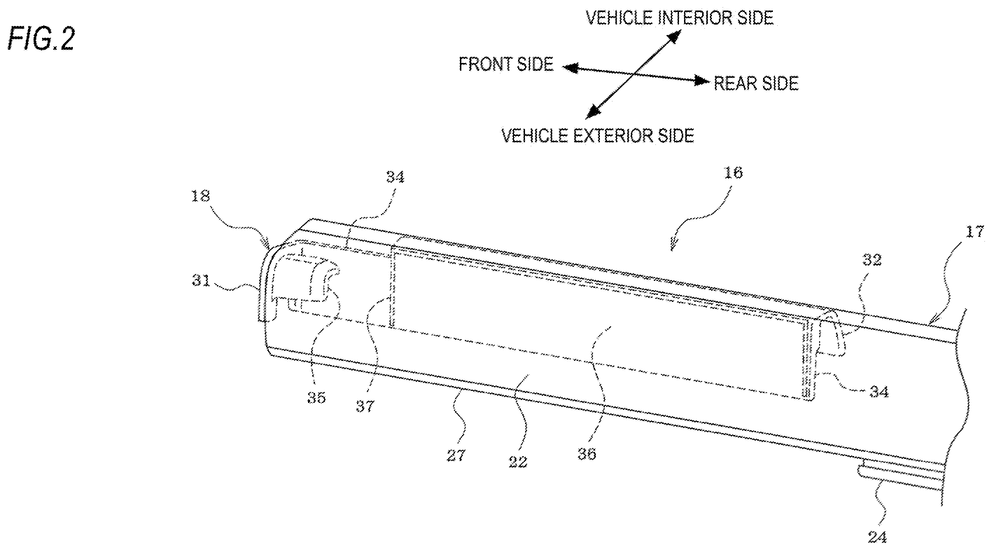

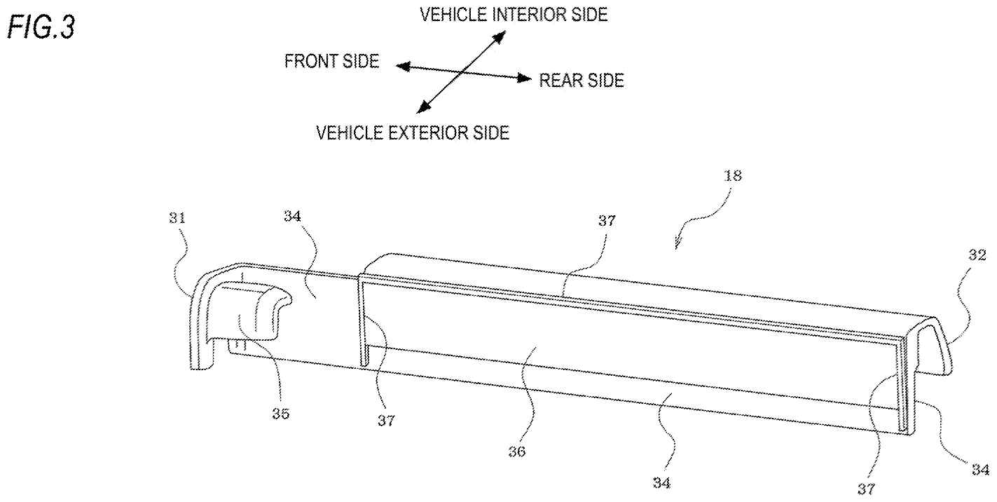

Next, a configuration of the belt molding 16 will be described with reference to FIGS. 2 to 8. As illustrated in FIGS. 2 to 5, the belt molding 16 includes a long molding main body 17 and an end cap 18 attached to a longitudinal end of the molding main body 17. As illustrated in FIGS. 3 to 7, the molding main body 17 is formed into a substantially U-shaped cross section by extrusion molding of a polymer material, and the molding body 17 includes a vehicle interior lateral wall portion 21 and a vehicle exterior lateral wall portion 22 facing each other and a top wall portion 23 connecting an upper side of the vehicle interior lateral wall portion 21 and an upper side of the vehicle exterior lateral wall portion 22. The vehicle interior lateral wall portion 21, the vehicle exterior lateral wall portion 22, and the top wall portion 23 are integrally provided.

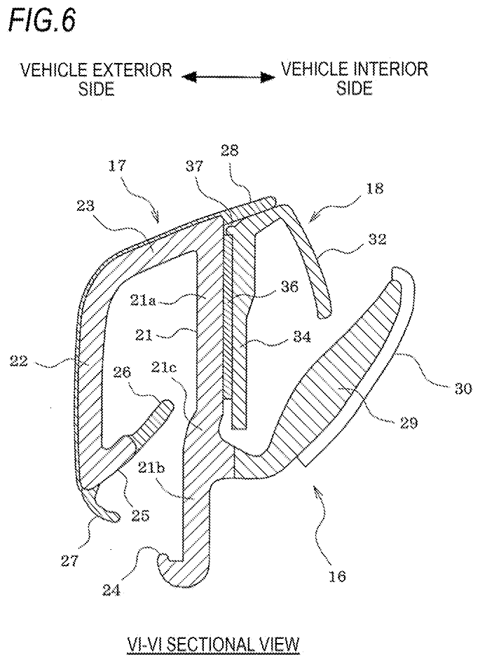

Further, as illustrated in FIGS. 6 and 8, at a lower end of the vehicle interior lateral wall portion 21, a locking portion 24 which can be locked to the flange portion 15 of the outer door panel 14 is integrally formed. At a lower end of the vehicle exterior lateral wall portion 22, a folded-back portion 25 protruding toward the vehicle interior lateral wall portion 21 is integrally formed. Further, at a tip of the folded-back portion 25, a holding lip 26 protruding obliquely upward toward the vehicle interior lateral wall portion 21 is integrally formed and, at the lower end of the vehicle exterior lateral wall portion 22, a vehicle exterior lip 27 protruding toward the outer door panel 14 side is integrally formed.

Further, as illustrated in FIG. 8, a flat plate-shaped lower portion 21b which comes into surface contact with the flange portion 15 of the outer door panel 14 when the molding main body 17 is attached to the flange portion 15, a flat plate-shaped upper portion 21a placed above the lower portion 21b, and a connecting portion 21c which connects the upper portion 21a and the lower portion 21b are integrally provided in the vehicle interior lateral wall portion 21. The upper portion 21a is provided at a farther interior side of the vehicle with respect to the vehicle exterior lateral wall portion 22 than the lower portion 21b, and the connecting portion 21c is provided at a position facing the holding lip 26 in a vehicle interior-external direction.

As illustrated in FIGS. 6 to 8, at an upper end of the upper portion 21a of the vehicle interior lateral wall portion 21, a design lip 28 which decorates an upper surface side of the molding main body 17 is integrally formed so as to protrude obliquely upward toward the vehicle interior side (window pane 13 side). Here, a protruding amount of the vehicle interior lip 29 toward the vehicle interior side is larger than a protruding amount of the design lip 28 toward the vehicle interior side. A vehicle interior lip 29 which protrudes obliquely upward toward the vehicle interior side is integrally provided to the lower side portion 21b of the vehicle interior lateral wall portion 21. A low friction material layer 30 is formed on a surface (at least the surface in contact with the window pane 13) of the vehicle interior lip 29 by flocking nylon pile or the like.

When the molding main body 17 is mounted over the flange portion 15 of the outer door panel 14, a tip side of the vehicle interior lip 29 comes into contact with the surface of the window pane 13, and thus the portion between the outer door panel 14 and the window pane 13 is sealed with the vehicle interior lip 29. Accordingly, it is possible to prevent foreign substances (for example, dust, dirt, water droplets, and the like) from entering the vehicle from outside the vehicle. Further when the window pane 13 moves up and down (opens and closes), foreign matter adhering to the surface of the window pane 13 can be wiped off with the vehicle interior lip 29.

The vehicle interior lateral wall portion 21, the vehicle exterior lateral wall portion 22, the top wall portion 23, the locking portion 24, and the folded-back portion 25 of the molding main body 17 are molded of a polymer material having higher rigidity than that of the vehicle interior lip 29. In this case, as a polymer material for molding the vehicle interior lateral wall portion 21, the vehicle exterior lateral wall portion 22, the top wall portion 23, the locking portion 24, and the folded-back portion 25 of the molding main body 17, for example, a thermoplastic resin such as TPO (olefin-based thermoplastic elastomer), PP resin (polypropylene resin), or PVC resin (polyvinyl chloride resin) having a durometer hardness (type D) of HDD50 to HDD80 (HDD70 in this embodiment) according to JISK7215 is used.

On the other hand, each of the vehicle interior lip 29, the design lip 28, the vehicle exterior lip 27, and the holding lip 26 is made of a polymer material which is softer and elastically deformable than the vehicle interior lateral wall portion 21 and the vehicle exterior lateral wall portion 22 of the molding main body 17. In this case, as the polymer material for molding respective lips 26 to 29, for example, a thermoplastic resin such as TPO, PP resin, PVC resin having a durometer hardness (type A) of HDA50 to HDA80 (HDA70 in this embodiment) according to JISK7215 is used.

The vehicle interior lateral wall portion 21, the vehicle exterior lateral wall portion 22, and the like of the molding main body 17 and the lips 26 to 29 are integrally formed by coextrusion molding (two-color extrusion molding).

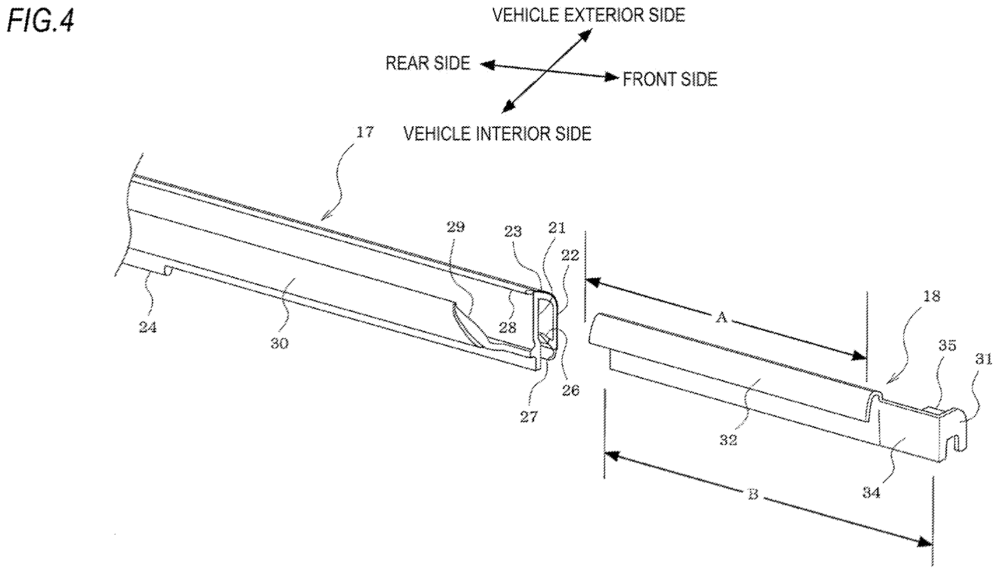

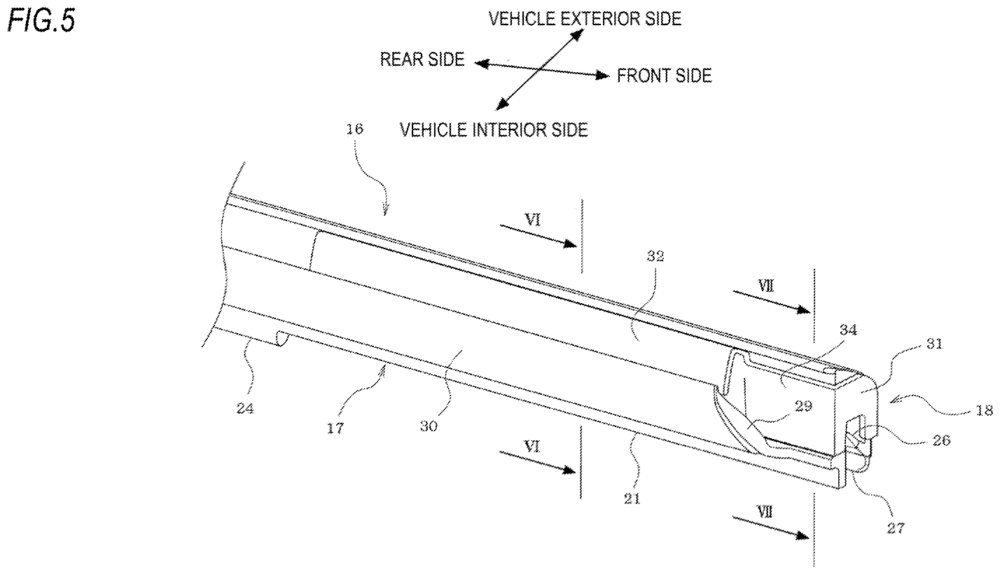

After the molding main body 17 is extruded, as illustrated in FIGS. 4 and 5, ends of the vehicle interior lateral wall portion 21, the locking portion 24, and the vehicle interior lip 29 are notched in order to prevent contact with the outer door panel 14 at a terminal of the molding main body 17.

Next, the end cap 18 attached to the terminal of the molding main body 17 in a longitudinal direction of the molding main body 17 will be described.

As illustrated in FIGS. 2 to 4, the end cap 18 includes a lid portion 31 which closes at least a part of a longitudinal end surface opening of the molding main body 17, a cover portion 32 which closes at least a part of an opening between the design lip 28 and the vehicle interior lip 29, a base portion 34 connecting the lid portion 31 and the cover portion 32, and an insertion portion 35 which protrudes from the lid portion 31 in the longitudinal direction of the molding main body 17 and is inserted into a gap between the vehicle interior lateral wall portion 21 and the vehicle exterior lateral wall portion 22.

As illustrated in FIGS. 5 to 8, the base portion 34 is located between the design lip 28 and the vehicle interior lip 29. Further, the base portion 34 extends in the longitudinal direction from the lid portion 31 along a vehicle interior surface of the vehicle interior lateral wall portion 21 and is at least partially fixed to the vehicle interior surface of the vehicle interior lateral wall portion 21. In this embodiment, the base portion 34 is adhesively fixed to the vehicle interior surface of the vehicle interior lateral wall portion 21 with a double-sided adhesive tape 36. The base portion 34 is formed so that a rib 37 (see FIG. 3) which abuts on, for example, edges of three sides of the double-sided adhesive tape 36 and positions the double-sided adhesive tape 36 protrudes toward the vehicle exterior side. The protruding amount of the rib 37 is set to be equal to or less than the thickness of the double-sided adhesive tape 36.

The cover portion 32 protrudes obliquely downward from at least a part of the upper end of the base portion 34 toward the vehicle interior lip 29. Further, in a state where the belt molding 16 is attached along the flange portion 15 of the outer door panel 14, at least a part of the cover portion 32 abuts on the vehicle interior lip 29 to close the gap between the design lip 28 and the vehicle interior lip 29 (see FIG. 8).

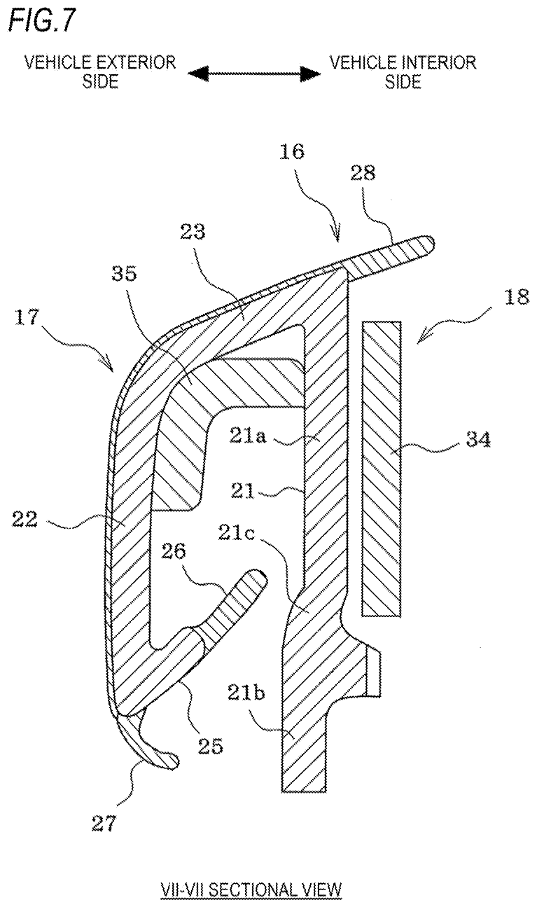

As illustrated in FIG. 7, the insertion portion 35 inserted in the gap between the vehicle interior lateral wall portion 21 and the vehicle exterior lateral wall portion 22 is set so that the length of the insertion portion 35 in the vehicle interior-external direction is substantially the same as the size of the gap between the vehicle interior lateral wall portion 21 and the vehicle exterior lateral wall portion 22. Accordingly, the movement of the end cap 18 in the vehicle interior-external direction with respect to the molding main body 17 is regulated by the insertion portion 35. In this embodiment, the insertion portion 35 is formed in an L-shaped cross section, but the shape of the insertion portion 35 may be any shape. In short, it is sufficient if the length of the insertion portion 35 in the vehicle interior-exterior direction is substantially the same as the size of the gap between the vehicle interior lateral wall portion 21 and the vehicle exterior lateral wall portion 22.

Meanwhile, as illustrated in FIG. 1, when traveling at high speed, if traveling wind passes through the gap between a door mirror 41 provided on the front door 11 and a corner garnish 42 and a vortex is generated, and then the vortex enters a V-shaped groove (gap between the vehicle interior lateral wall portion 21 and the vehicle interior lip 29) in the belt molding 16, wind noise is generated and enters the vehicle.

In consideration of this point, in this embodiment, in order to prevent the vortex generated by the traveling wind passing through the gap between the door mirror 41 and the corner garnish 42 from entering the V-shaped groove in the belt molding 16, a length A (see FIG. 4) of the cover portion 32 of the end cap 18 in the longitudinal direction (vehicle front-rear direction) is set to, for example, 90 mm, and a length B of the entire end cap 18 in the longitudinal direction (vehicle front-rear direction) is set to, for example, 110 mm. As a result, when the end cap 18 is attached to the end of the molding main body 17 on the vehicle front side, the cover portion 32 of the end cap 18 is located around the door mirror 41, and thus the cover portion 32 is configured to prevent the vortex generated by the traveling wind passing through the gap between the door mirror 41 and the corner garnish 42 from entering the V-shaped groove in the belt molding 16. Here, when the length B of the end cap 18 is much longer than 110 mm, it becomes difficult to assemble the end cap 18 to the molding main body 17 and the appearance deteriorates.

The end cap 18 is injection molded with a polymeric material. As the polymer material for molding the end cap 18, for example, a thermoplastic resin such as styrene-based thermoplastic elastomer, PP resin, or PVC resin having a durometer hardness (type A) of HDA50 to HDA80 (HDA62 in this embodiment) according to JISK6253 is used. In this embodiment, as illustrated in FIG. 8, when the window pane 13 is closed, the vehicle interior lip 29 abuts on the window pane 13 and bends and deforms, and thus the vehicle interior lip 29 abuts on the cover portion 32 of the end cap 18 and elastically deforms the cover portion 32. Thus, the cover portion 32 is made of a polymer material which is softer than that of the vehicle interior lip 29.

According to the embodiment described above, the cover portion 32 of the end cap 18 attached to the longitudinal end of the molding main body 17 closes the V-shaped groove between the vehicle interior lateral wall portion 21 of the molding main body 17 and the vehicle interior lip 29, in such a manner that it is possible to prevent the traveling wind flowing along the window pane 13 from entering the V-shaped groove which is a source of wind noise. As a result, the wind noise when the vehicle is traveling can be reduced and the harshness of the ears can be prevented.

In addition, the end cap 18 is formed with the insertion portion 35 which protrudes from the lid portion 31 in the longitudinal direction of the molding main body 17 and is inserted into the gap between the vehicle interior lateral wall portion 21 and the vehicle exterior lateral wall portion 22. Therefore, the movement of the end cap 18 in the vehicle interior-exterior direction with respect to the molding main body 17 can be regulated by the insertion portion 35. As a result, the variation (assembly variation) in a mounting position of the end cap 18 with respect to the molding main body 17 can be reduced and the effect of reducing wind noise can be stably obtained.

Further, according to the embodiment described above, since the base portion 34 of the end cap 18 is adhered and fixed to the vehicle-interior-side surface of the vehicle interior lateral wall portion 21 with the double-sided adhesive tape 36, there is an advantage that the work of fixing the base portion 34 of the end cap 18 to the vehicle-interior-side surface of the vehicle interior lateral wall portion 21 can be easily performed. However, means for fixing the base portion 34 of the end cap 18 to the vehicle-interior-side surface of the vehicle interior lateral wall portion 21 is not limited to the double-sided adhesive tape 36 and, for example, it may be adhesively fixed with an adhesive or the like.

Further, according to the embodiment described above, since the rib 37 configured to position the double-sided adhesive tape 36 is formed on the base portion 34 of the end cap 18, there is an advantage that the adhesive position of the double-sided adhesive tape 36 with respect to the base portion 34 of the end cap 18 can be easily positioned by the rib 37. However, the present disclosure may have a configuration in which the rib 37 is omitted.

In the embodiment described above, the cover portion 32 of the end cap 18 is located around the door mirror 41, but the position (that is, the position for reducing the wind noise) of the cover portion 32 of the end cap 18 may be changed. In short, it is sufficient if the cover portion 32 is positioned at a portion where wind noise is generated by the wind entering the V-shaped groove between the vehicle interior lateral wall portion 21 of the molding main body 17 and the vehicle interior lip 29.

Further, the present disclosure is not limited to the front door of the vehicle and may be applied to other doors such as a rear door. In short, it is sufficient if the cover portion 32 of the end cap 18 is positioned at a place where the wind entering the V-shaped groove in the belt molding is the source of the wind noise.

In addition, it goes without saying that the present disclosure can be carried out by making various changes without changing the gist, such as changing the length of the end cap 18 and the length of the cover portion 32, or changing the configuration of the molding main body 17.

What is claimed is:

1. A long belt molding configured to be mounted along an upper edge of a door panel of a vehicle door to which a window pane is attached so as to be able to be moved up and down, the belt molding comprising:
a long molding main body including:
a vehicle interior lateral wall portion and a vehicle exterior lateral wall portion which face each other;
a top wall portion which connects an upper side of the vehicle interior lateral wall portion and an upper side of the vehicle exterior lateral wall portion;
a design lip which protrudes from an upper end of the vehicle interior lateral wall portion to a vehicle interior side; and
a vehicle interior lip which protrudes obliquely upward from a part of the vehicle interior lateral wall portion which is located lower than the design lip toward the vehicle interior side, the vehicle interior lip configured to seal a gap between the vehicle interior lateral wall portion and the window pane; and
an end cap attached to an end of the molding main body in a longitudinal direction of the molding main body, the end cap including:
a lid portion which closes at least a part of an end surface opening of the molding main body in the longitudinal direction;
a cover portion which closes at least a part of an opening between the design lip and the vehicle interior lip; and
a base portion which connects the lid portion and the cover portion,
wherein the base portion is located between the design lip and the vehicle interior lip, extends in the longitudinal direction from the lid portion along a vehicle-interior-side surface of the vehicle interior lateral wall portion, and is at least partially fixed to the vehicle-interior-side surface of the vehicle interior lateral wall portion, and
wherein the cover portion protrudes obliquely downward toward the vehicle interior lip from at least a part of an upper end of the base portion and, in a state where the belt molding is mounted along the upper edge of the door panel, at least a part of the cover portion is in contact with the vehicle interior lip to close a gap between the design lip and the vehicle interior lip.

2. The belt molding according to claim 1,
wherein the end cap includes an insertion portion which protrudes from the lid portion in the longitudinal direction of the molding main body, the insertion portion being inserted into a gap between the vehicle interior lateral wall portion and the vehicle exterior lateral wall portion.

3. The belt molding according to claim 1,
wherein the base portion of the end cap is adhesively fixed to the vehicle-interior-side surface of the vehicle interior lateral wall portion with a double-sided adhesive tape.

4. The belt molding according to claim 3,
wherein a rib that positions the double-sided adhesive tape is formed on the base portion of the end cap.

5. The belt molding according to claim 1,
wherein the vehicle interior lip is made of a first polymer material, and
wherein the cover portion is made of a second polymer material softer than the first polymer material.

6. The belt molding according to claim 1,
wherein a protruding amount of the vehicle interior lip toward the vehicle interior side is larger than a protruding amount of the design lip toward the vehicle interior side.
